(19) United States
(12) Patent Application Publication
(10) Pub. No.: US 2011/0175905 A1
(43) Pub. Date: Jul. 21, 2011

(54) INFOSHAPE: DISPLAYING MULTIDIMENSIONAL INFORMATION

(75) Inventor: Jie Hao, Dallas, TX (US)

(73) Assignee: American Propertunity, LLC.

(21) Appl. No.: 12/830,318

(22) Filed: Jul. 3, 2010

Related U.S. Application Data
(60) Provisional application No. 61/295,242, filed on Jan. 15, 2010.

(51) Int. Cl. G06T 15/00

(52) U.S. Cl. 345/419

(57) ABSTRACT

Apparatus for displaying data records of plural dimensions as a three dimensional shape, wherein the shape has an area on the surface of said shape for ones of said data records, and at least one visual feature of said area is responsive to a relevance factor value of its corresponding record in relation to a reference criterion and said relevance factor value is determined by an approximation or distance to said criterion.

### CROSS-REFERENCE TO OTHER APPLICATION

This application claims the benefit of U.S. Provisional Application No. 61/295,242 filed Jan. 18, 2010, which is hereby incorporated by reference.

### DESCRIPTION OF RELATED ART

The present application relates to visual presentation of data, and more particularly to displaying multidimentional information as a three-dimensional shape on a display device.

The rapidly growing volume of multidimensional information provided by various data collecting applications, instruments, and especially the internet, requires techniques for meaningful interpretations and visual representations. Simple information visualization techniques, such as line graphs and scatter plots, have been widely used for decades. With the help of line graphs or plotted points, viewers can easily understand one dimensional information, e.g., a function of one variable. Similarly, three-dimensional line graphs and scatter plots can describe the relationships among three variables.

When the number of variables is four or five, animation techniques and virtual environments may be used to convey essential multi-variable relationships. For relationships beyond five variables, standard geometric projection techniques are ineffective and human perception system ceases to comprehend the meaning of provided information.

Modern multidimensional visualization techniques involve encoding dimensionalities in graphical elements. Many multidimensional visualization techniques, such as parallel coordinates by Inselberg, et al. (See, The Visual Computer, vol. 1, 1985, pp. 69-97 and Proc. 1^{st} Conference of Visualization, 1990, pp. 391-370) can theoretically visualize multidimensional information with a large dimensionality. In the early years, visualization serves mostly, if not only, to convey results of statistical computation and data mining algorithms. Over the last decade, it has been extended to the fields of data processing, human-information interaction, measuring test and data management.

Most previous graphical representations only intend to express the detailed features of the information under study. Few offer graphical evaluation and comparison of information at a high yet intuitive level.

In daily life, a high level view is always the starting point for a quick understanding of a complex system. For example, we usually encounter questions such as: “Are the medical data gathered from a patient in the acceptable range?” “Do the new products satisfy customers' specifications?” and “how does the quality of life in the US compare with the rest of the world?” Such questions can be generalized as how to quickly understand and compare multidimensional information under a set of criteria, which requires an overview of the complex information captured at a glance.

Traditional visualization techniques that aim at illustrating information in detail are not suitable for such purposes. Many multidimensional visualization techniques have been proposed as reviewed below. Parallel coordinates visualization (see e.g., Inselberg, et al.) uses parallel axes instead of perpendicular axes to visualize multi-dimensional information. Each vertical line is used for the projection of a dimension or an attribute. The maximum and minimum values of the dimension or attribute are scaled to the upper and lower boundaries on the vertical line. N-dimensional data are visualized as polylines which consist of p-ledges. Each edge connects to the vertical lines at the right dimensional value. Circular parallel coordinates (see Hoffman P. E., “Table Visualizations: A Formal Model and Its Applications”, Ph.D Dissertation, Computer Science Dept., Univ. of Massachusetts at Lowell, 1999) modify parallel coordinates by simply arranging the axes radially from the center to the edge of a circle. Large dimension values tend to be mapped on the axes near the circle, while small dimension values are mapped near the center. Therefore, N-dimensional data are visualized as n-edges polygons, which are normally named a star glyph (see Chambers J. M., Clevelang W. S., Kleiner B. and Tukey P. A., Graphical Methods for Data Analysis, Belmont, Calif.: Wadsworth Press, 1983 and Proc. of IEEE Symposium on Information Visualization, 2005, pp. 119-24).

A visualization technique (see Proc. Of IEEE Symposium on Information Visualization, 2005, pp. 149-156) has been used to integrate parallel coordinates and star glyph. Andrews' Curves visualization (see Biometric, Vol. 28, No. 1, 1972, pp. 125-136) shows multidimensional information by a function, that N-dimensional data are transformed to smooth curves.

On one hand, these multidimensional visualization techniques successfully project data into 2D objects whose shapes distinguish the data being visualized individually. On the other hand, overlapping 2D shapes weaken the ability of visual representations of information sets as a whole. Researchers have proposed techniques to solve this problem. For example, techniques such as clustering (see, e.g., Proc. of IEEE Symposium on Information Visualization, 2005, p. 17 and Information Visualization, Vol. 5, No. 2, 2006, pp. 125-36), dimension reordering (see, e.g., Proc. of IEEE Symposium on Information Visualization, 2004, pp. 89-96) and outlier-preserving focus+context visualization (see, e.g., IEEE Trans. on Visualization and Computer Graphics, 2006, pp. 893-900), are applied to reduce overlapping cluttering and convey the meaning of the visualized information set as a whole.

Implicit shape visualization (see, e.g., Information Visualization 1998, New York: IEEE Press, 1998, pp. 121-29) maps multidimensional information to uniformly spaced vectors which emanate from the center of a sphere. The length of a vector is scaled on the underlying data value. A uniform point source field function is placed at the end of each vector. Then an isosurface can be constructed from the resulting density field. The generated 3D object has a “blobby” shape on which bulges stands for the big value of data in that direction. Implicit shape visualization produces an integrated 3D object.

Other visualization techniques such as 3D glyphs also visualize information sets as 3D objects. These techniques do not directly visualize the difference between information sets, since one has to obtain the difference of information sets by mentally switching between different renderings of information sets.

Woodering and Shen (see IEEE Trans. on Visualization and Computer Graphics, Vol. 12, No. 5, 2006, pp. 909-16) propose a volume shade where the user can easily create comparisons. It allows users to specify a numerical operation on information sets and visualizes the relationships. VisDB (see, e.g., IEEE Computer Graphics and Applications, September 1994, pp. 40-49) and the technique proposed in Proc. of IEEE Symposium on Information Visualization, 2001, pp. 105-12 visually compare and explore query result sets. The VaR technique (see, e.g., Proc. of IEEE Symposium on Information Visualization, 2004, pp. 73-80 and IEEE Transactions on Visualization and Computer Graphics, Vol. 13, No. 3, 2007, pp. 494-507) extends the spiral arrangement in VisDB to ensure users a visual interactive exploration of information up to hundreds of dimensions. It projects multidimensional information to a 2D space, rather than 3D as in InfoShape.

T. A. Barg et al. in U.S. Pat. No. 6,707,454 discloses visualization of pivot tables in a database as bar chart or multiscape landscape. D. C. Robbins in U.S. Pat. No. 6,819,344 discloses visualization of data as a three dimensional helical path. E. Kandogan in U.S. patent application 9/860,968 teaches representing multidimensional data into two dimensions. H. E. Cline in U.S. Pat. No. 5,659,629 teaches the use of a surface coil of internal structures of internal structures of a solid object to display the surface image of this object.

### SUMMARY

This application presents new approaches to visualizing multidimensional information as a three-dimensional sphere according to a pre-defined set of criteria.

In one aspect of some embodiment of this invention, if a multidimensional information set satisfies a given set of criteria it will be represented as a perfect sphere. Otherwise, the distortions on the sphere indicate defective contents whose information does not satisfy some of the criteria.

In another aspect, many sets of multi-dimensional information can be compared by simply inspecting one or more corresponding spheres.

Why Three-Dimension?

Springmeyer et al. (see Proc. IEEE Visualization, 1992, pp. 235-42) showed that two-dimensional displays are usually used to convey precise relationships, whereas three-dimensional displays are to gain a qualitative understanding and represent ideas. 2D displays beat 3D when tasks need to show detailed specifications, such as focused analysis, precise navigation, and distance measurement. In contrast, 3D displays facilitate shape recognition, approximate navigation and position, and 3D space survey. According to Pizlo in his 2008 book, the only way to study the role of simplicity in shape perception is to use 3D visualization (or 2D images of 3D objects). In other words, 3D objects adapt to the human's perception system better than 2D objects.

One aspect of some embodiment of this invention is to present the similarities of global contents and highlight the differences among multi-dimensional information sets. The comparative assessment of multi-dimensional information sets is represented at a high level and local details can be viewed by zooming in or drilling down.

Why Shape?

Shape is a natural visual perception for human beings. According to Marr, the process of determining how a shape is interpreted as something “deep buried in our perception machinery”. Inspired by economical Paleolithic animal representational arts, Halverson explored why the visual dimensions in these arts are so limited and why these minimally represented arts are so recognizable. By pointing out that the profiles of animals are chosen in preference to other views, Halverson's research proved the importance of shapes in the perception process. Thus in one aspect, a shape is used to represent the global view of multi-dimensional information.

Why Spheres?

Sphere as a 3D shape can be detected and identified easily due to its equidistance property that makes sphere simpler than other 3D objects. An experiment by Goethe proves that an afterimage of a square becomes more and more circular with the passage of time. According to Koffa, the observers' internal forces, which bias a percept toward simplicity, beat the external forces which are produced by the square because the square is not as simple as the “simplest form”—circle. According to Gestalt psychology, the equidistance property ensures sphere the “simplest form”, and thereby easier to detect and identify than other 3D objects.

Even though the preferred embodiments use sphere as an example, a person of ordinary skill in the art can easily adopt other shapes such as cube to meet the need of a specific application.

Visual feature are added to data that do not have obvious visual property. Data that do not represent a three dimensional physical object are displayed as a three dimensional shape. Data of multi-dimensions are displayed as a three dimensional shape.

According to one aspect of some embodiment of the invention, an apparatus for displaying data records of plural dimensions as a three dimensional shape comprises a display device displaying at least part of said three dimensional shape, wherein said shape further comprises an area on the surface of said shape representing at least one of said data records, and at least one visual feature of said area is responsive to a relevance factor value of its corresponding record in relation to a non-geographic criterion wherein said relevance factor value is determined by an approximation to said criterion.

According to another aspect, an apparatus for displaying data of a plurality of records as a three-dimensional shape, comprises: a memory for storing said data records in a table, a processor assigning a non-overlapping regular area on the surface of said shape for at least one of said data records, and assigning a surface shape information of said area in dependence of a criterion, wherein said criterion is applied to a subset of said record; and a display device displaying said area wherein said processor sets visual feature of said area based on result of applying a function to said criterion.

According to another aspect, an apparatus for displaying data of a plurality of records as a three-dimensional shape, comprises: a display device displaying at least part of said three dimensional shape, wherein said shape further comprises an area of plural positions on the surface of said shape, and the steps of deriving ones of said positions comprising the actions of: assigning at least one pixel to one of said records for one of said dimensions, arranging said pixels in a spiral shaped window for one of said data dimensions based on a criterion such that a data record that has a corresponding pixel or pixels whose relative distance to the center of said window is responsive to a relevance factor value, wherein said criterion is applied to a subset of said records; and mapping one of said pixels to ones of said positions, wherein the distance of said position to the center of said shape is responsive to said relevance factor value of the data record corresponding to said pixel wherein said relevance factor value is determined by the approximation to said criterion.

### BRIEF DESCRIPTION OF THE DRAWINGS

A more complete appreciation of the aspects of the embodiments and many of the attendant advantage thereof will be readily obtained as the same becomes better understood by reference to the following detailed description when considered in connection with the accompanying drawings, wherein:

FIG. 1 schematically shows an example of a conceptual model for RInfoShape.

FIG. 2 shows an example of psoudocode of rendering model.

FIG. 3A shows an example Java program that the RInfoShape is applied to.

FIG. 3B shows the compilation result of applying RInfoShape to the Java program of FIG. 3A.

FIG. 3C shows an area distribution example using dimensional area distribution function or ADF( ).

FIG. 4A shows an example of area shape on F* sphere function.

FIG. 4B shows an example of area shape on Tine function.

FIG. 4C shows an example of area shape on cross function.

FIG. 4D shows an example of area shape on Hunch function.

FIG. 5A shows the result of applying RInfoShape to the Java program shown in FIG. 3A.

FIG. 5B shows the result of applying RInfoShape to the Java program with added visual feature: color.

FIG. 6A schematically shows a conceptual model of DInfoShape.

FIG. 6B shows an example of original pixel arrangement in VisDB.

FIG. 6C shows an example of pixel arrangement in DInfoShape.

FIG. 7 shows a 2D arrangement made by DinfoShape where the same data in the overall window and individual dimension windows may have different positions.

FIG. 8A shows the 2D arrangement, of randomly generated 15-dimension information set with 639 records.

FIG. 8B shows the mapped 3D shape from the 2D example in FIG. 8A.

FIGS. 9A-D show examples of DInfoShape shapes displaying 5-dimensional information in four different data sets.

FIGS. 10A-D show DInfoShape displayed life tables of total U.S. population for (A) male, (B) female, (C) white and (D) black ethnic races

FIG. 11A shows DInfoshape displayed shape setting the life table for the white population as the reference and that for the black population as the examined data.

FIG. 11B shows DInfoshape displayed shape setting the life table for the black population as the reference and that for the white population as the examined data.

FIG. 12A shows DInfoShape displayed a massive distortion indicating that the male population's life expectation is lower than that of the female population.

FIG. 12B shows DInfoShape displayed shape indicating that, except for the “Number of Dying” dimension, all death data for the female population meet the criterion in the male life table.

### DETAILED DESCRIPTION OF THE PREFERRED EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Also, like reference numerals referenced in the drawings designate identical or corresponding parts throughout the several views.

First, multidimensional information needs to be preprocessed and formatted into a fixed structure before being translated into graphical representations. One embodiment of this invention considers the table format which was first introduced by Card et al. (see Card, et al., Readings in Information Visualization—Using Vision to Think, San Francisco, Morgan Kaufmann, 1999). Visualizing information arranged in tables is termed table visualization. A table is a structured format organized by rows and columns. Card et al. defined rows as dimensions and columns as records. However, a table here is viewed in a more intuitive way: rows and columns denote the records and dimensions respectively.

The term “dimension” here also has a different meaning to that provided in Wong and Bergeron (see Scientific Visualization Overviews, Methodologies, and Techniques, Los Alamitos, Calif.: IEEE CS Press, 1997, pp. 3-33) where “dimension” refers to independent variables whereas “variates” refer to dependent variables. However, “dimensions” here denote both dependent and independent variables, and “record” here denotes a tuple expressing the relationships among dimensions.

A table here comprises multiple records and can be naturally viewed in two orthogonal ways. The first is to horizontally split a table into multiples of records, offering “Record View”. The other is “Dimension View” that splits a table into units vertically, and usually each column contains data of one dimension. These two views project different aspects of a table.

A Record View regards a record as an integral unit and therefore emphasizes the individuality of records. In contrast, a Dimension View does not emphasize the properties of individual records, but a view of each dimension. It conveys statistical distribution over a single dimension. The Record View and Dimension View together reflect the natural row-column structure of a table model and lead to the following two preferred embodiments: (1) Record InfoShape, or RInfoShape for short, and (2) Dimension InfoShape, or DInfoShape.

Notations

R={R₁, R₂, . . . , Rₙ} is a set of records.

A ={A₁, A₂, . . . , Aₙ} is a set of areas and Aᵢ (1<=i<=n) specifies the area of Rᵢ on the sphere: Aᵢ {[α_{from}, αₜₒ], [β_{from}, βₜₒ]} where [α_{from}, αₜₒ] and [β_{from}, βₜₒ] denote the longitude and latitude ranges on the sphere respectively.

Area Distribution Function (ADF ( )) calculates area set A.

F={F*, F₁, F₂, . . . , Fₘ} is a set of surface functions. F* is the normal sphere function. Fᵢ can be any user-defined surface function.

C={C₁, C₂, . . . , Cₖ} is a pre-determined set of criteria.

S={S*, S₁, S₂, Sₖ} is a set of information validity status. S* denotes the valid status. Invalid status Sᵢ indicates the violation of criterion Cᵢ.

V={V₁, V₂, . . . , Vₜ} is a user-defined set of Visual Features. A visual feature can be any visual clue used to encode information.

Rᵢ(aεA, sεS, fεF, vεV) denotes the ith record and a, s, f, v denote the area, validity status, surface function and visual feature respectively.

1. RinfoShape

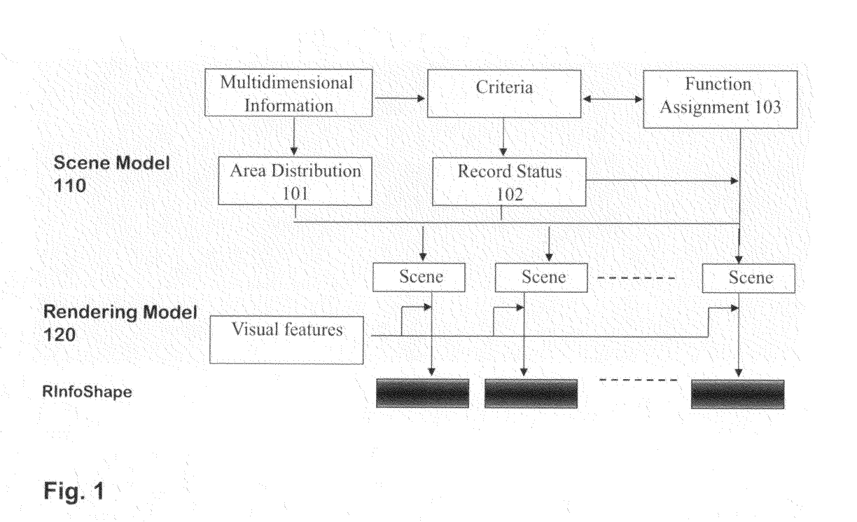

FIG. 1 presents a schematic diagram of the conceptual model of the first embodiment: RInfoShape. This model is used for the purpose of explaining the embodiment and comprises scene model (110) and rendering model (120), mapping information into a three dimensional graphical presentation in two steps.

A record is associated with a visual object. To locate a visual object on a specific area of the sphere, RInfoShape uses an area distribution function (101), namely ADF( ) that returns a unique area for a given visual object. ADF( ) can be defined based on different applications. Various functions can be developed to assign a unique area on the sphere to a record. For example, a spherical helix function can be used to divide a sphere into non-overlapping stripes and each stripe can be assigned to a record. A dimensional area distribution function maps two dimensions of a record into the longitude and latitude on the sphere. The two selected dimensions in general uniquely identify a specific record so that the location on the sphere is unique.

A status is assigned to a record to denote the record's validity, determined by examining the record against all related criteria. If a record satisfies all of its associated criteria, Record Status (102) assigns a valid status S*; otherwise, it assigns the record a status sᵢ(sᵢεS) which denotes the violation of cᵢ (for simplicity of presentation, cᵢ here represents a criterion or a subset of criteria in C).

Function assignment (103) assigns each record a surface function according to its record status. F* is assigned to a record with a valid status. fᵢ(fᵢεF) is assigned to a record who has a sᵢ status.

The rendering model (120) assists users to identify the records' validity by adding visual features (such as color and/or texture). It lets a user to define visual features for individual visual objects that fit the user's own cognition.

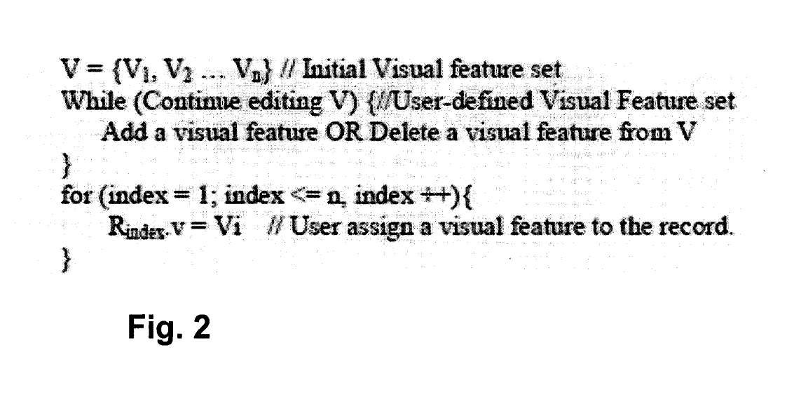

FIG. 2 shows an example pseudocode for a rendering model 120 embodiment

### RInfoShape Example

### Evaluating a Java Program

We discuss our experiment of applying RInfoShape to evaluate a Java program. The resulting graphical representation assists users to understand the problems of the example program under compilation criteria.

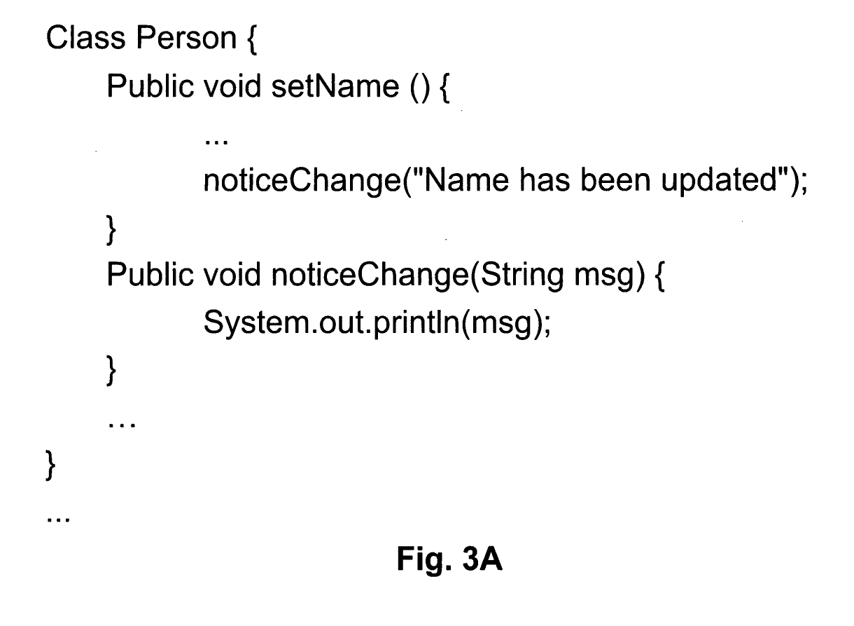

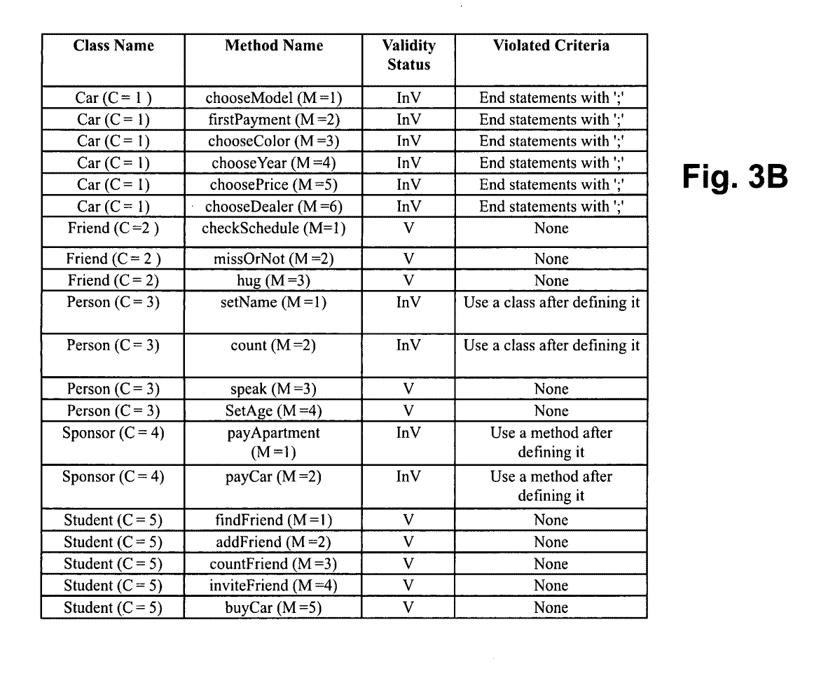

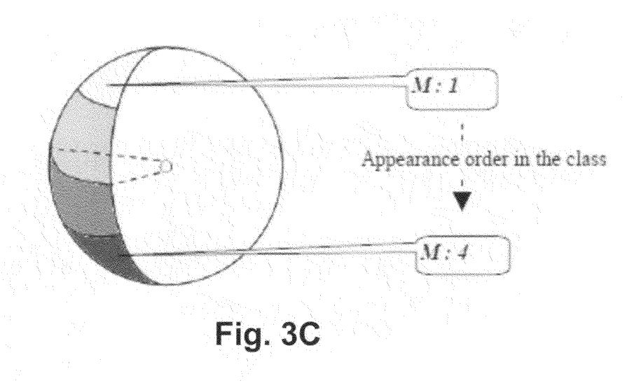

A constructed Java program should follow predetermined syntactical and semantic criteria. The example program in FIG. 3A evaluated by RInfoShape comprises five classes, namely Person, Sponsor, Student, Friend, and Car. Each class has several methods. For simplicity, only syntactical requirements are considered as criteria. The formal definition of the criteria is given as:

C={cᵢ|cᵢ is a syntax criterion, i=1, 2, 3 . . . }.

A quick overview of the example program under the criteria can reveal how well the program passes the compilation process.

FIG. 3B summarizes of the evaluation results of the example code. Each record describes a compilation result of a method in a class. Dimensions “Class” and “Method” together specify uniquely a method (note that the program has no method overloading). “C” represents the alphabetical order of a class name and “M” represents the order of the method's appearance in the class. The record set can be defined as:

R={R_{(c,m)}|R_{(c,m)} is a record in compilation description table}.

The “V” in “Validity Status” denotes that the record satisfies all the criteria and “InV” indicates that at least one criterion is violated. Dimension “Violated Criteria” is self explained. For instance, the following a piece of code generates the first record in FIG. 3B.

Then, ADF( ) is used to determine the area occupied by each record on the surface of the sphere. The preferred embodiment uses dimensional area distribution function due to two properties. First, dimensional ADF( ) returns a unique area for each record. Second, dimensional ADF( ) aims at mapping two information properties to longitude and latitude of the sphere, which matches the human's perception of a sphere. C and M are applied in the dimensional ADF( ) The area of R_{(c,m)} can be obtained, for example, using Equation <1> below, where C_{NO} denotes the number of classes and M_{NO} denotes the number of methods contained in the class c.

a=ADF_{(c,m)}=[2Π*c/C_{NO},2Π*(c+1)/C_{NO}] and [Πm/M_{NO},Π*(m+1)/M_{NO}] <1>

Equation <1> above maps the class and method indices to the longitude and latitude respectively. This mapping ensures two desirable features. First, the spaces on the same longitude belong to the methods in the same class. Second, geographical distance to the North Pole denotes the order of appearance in that class. FIG. 3C shows that the locations of four methods belonging to one class.

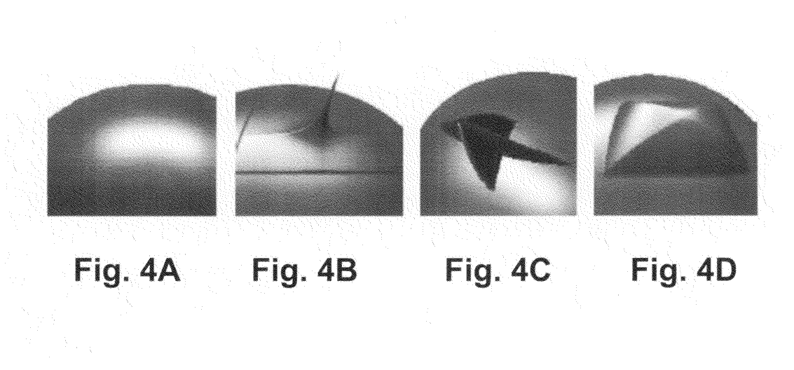

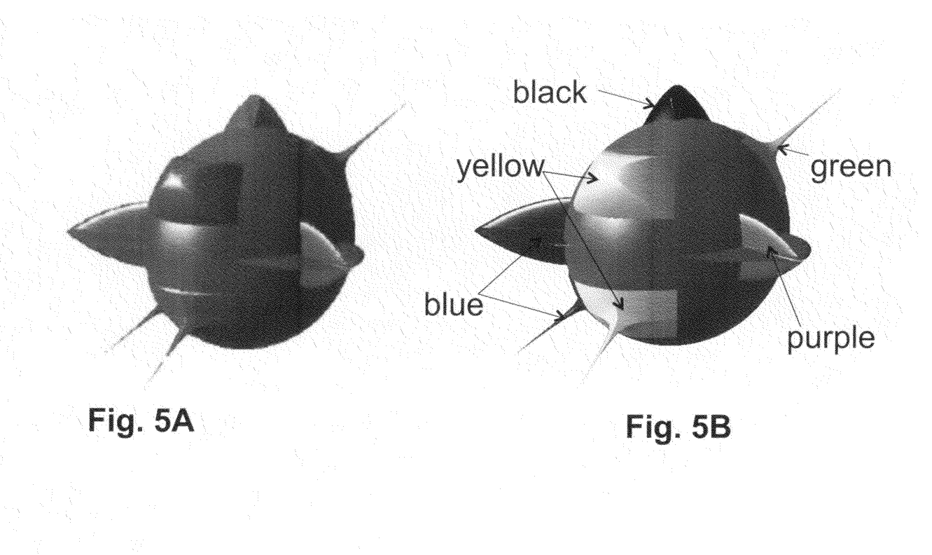

FIGS. 4A-D illustrates four area shape examples generated by surface distortion functions. FIG. 4A shows that Function F* can be assigned to indicate validity status of methods. FIGS. 4B-D show respectively that Tine, cross, and hunch can be functions assigned by users to indicate specific criteria violations. In our experiment, we assigned the Tine function to represent the criterion “use a method after defining it,” Cross function “use a class after defining it” and Hunch function “end statements with ‘;’.” Following these function assignments, the example program's evaluation by compilation can be visualized in FIG. 5A. A spike on the sphere indicates that the method assigned to that area violates certain criteria. The shape of the spike indicates which criterion is violated.

Thus, the three-dimensional shape as shown in FIG. 5A displayed by the rendering model intuitively assists users to understand the program under the pre-defined compilation criteria. Further, a preferred embodiment may allow users to see more information about criteria violation from the graphic perspective. In the rendering model, users have many options to define visual features to facilitate their understanding. Even though our experiment allows the visual feature V to consist of only Color as an example, other visual features can be easily used by a person of ordinary skill in the art.

For example, color can be used to distinguish the invalid methods among different classes. In our experiment, we map the dimension “Class Name” to colors. For instance, we use blue, yellow, purple, green, and black to illustrate the Car, Friend, Person, Sponsor, and Student respectively. FIG. 5B illustrates the visualization of the example program after colors are applied.

DinfoShape

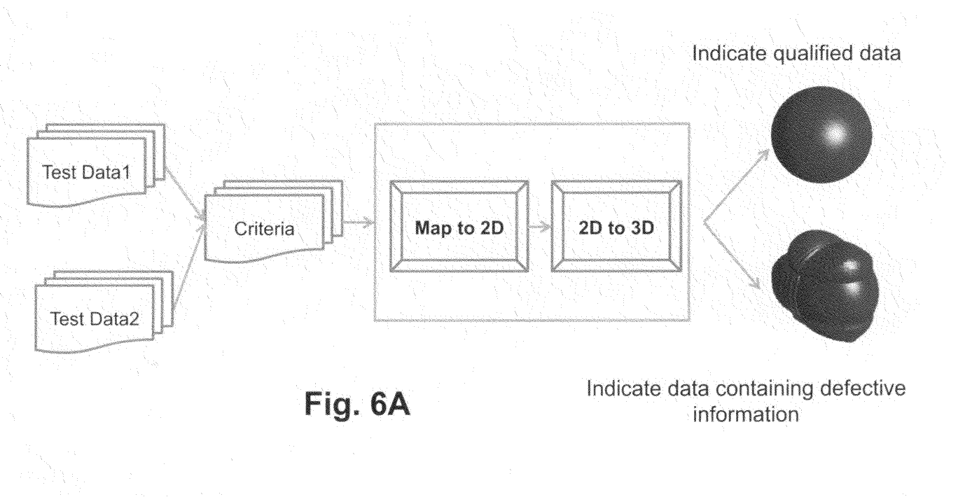

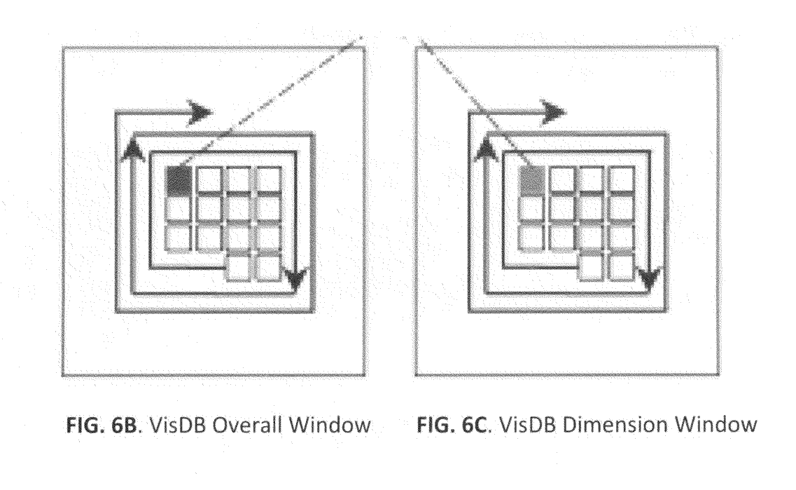

The embodiment DInfoShape does not assign each record a unique area on the sphere where all visual features are integrated, instead, it assigns a unique area to each dimension. As schematically shown in FIG. 6A, DInfoShape comprises two steps: (1) arrange the multi-dimensional information on a 2D panel, and (2) map the 2D plane to a 3D sphere.

VisDB 2D Arrangement

This embodiment uses VisDB as a tool for the 2D information arrangement. VisDB relates the visualization of an overall result to that of the individual dimensions, wherein the display window is divided into several sub-windows which are arranged next to each other. Usually, the upper-left sub-window is for the overall visualization, and the other sub-windows visualize individual dimensions.

Shown in FIGS. 6B and C are the spiral shaped arrangements made by VisDB. The distance to the spiral center denotes the approximation or how much the associated information matches the criteria. The approximation of a record (in overall sub- window as shown in FIG. 6B) and the individual dimension of that record (in individual dimension window as shown in FIG. 6C) are represented by a relevance factor (see appendix for an example of calculating the relevance factor). In a preferred embodiment, data with the highest relevance factors are centered in the middle of the overall window. The smaller the relevance factors are, the closer the corresponding data are positioned to the edges of the overall window. Moreover, in the dimension windows, data are placed at the same relative position as they are in the overall window.

Thus, in VisDB the position for each record in the dimension window is determined by its position in the overall window, the distance to the center in individual dimension windows does not reflect the approximation of data in that dimension.

DInfoShape 2D Arrangement

The embodiment of DInfoShape maintains the consistency of spiral properties in both overall and dimension windows. In the overall window, DInfoShape arranges data in the descending order of relevance factors. The data in the center of overall window denote those violating certain criteria. The closer a pixel's position to the edges of the window, the better the record matches the criteria. Similarly, in dimension windows, data are arranged based on the distance of that dimensional attributes of records in descending order (see appendix for distance calculation).

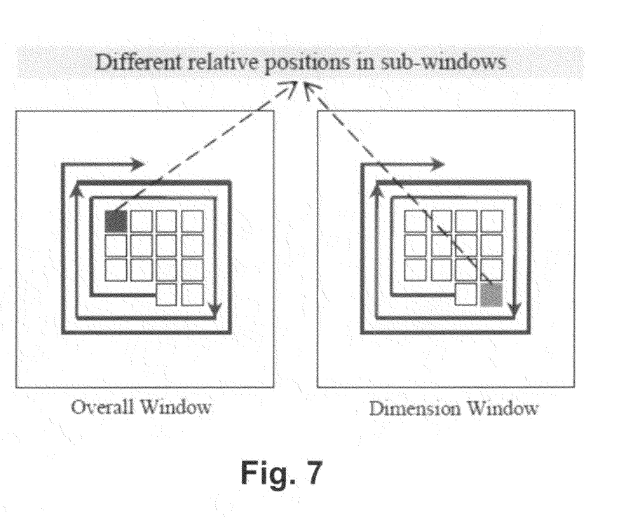

FIG. 7 shows the 2D arrangement made by the DInfoShape where the same data in the overall window and individual dimension windows may have different positions. This modified arrangement clearly visualizes the distance of the data to the criteria in the spiral layout in each window, thereby helps to evaluate either the overall or a single attribute of that data. Furthermore, InfoShape takes 3D shape as a visual cue, and delivers information much quicker than maintaining the same relative positions for corresponding data compared with the 2D arrangement made by VisDB.

DInfoShape uses the similar color scheme as that in VisDB, ranging from yellow to green, cyan to blue, and magenta to red, to denote the approximation with respect to the criteria in descending order.

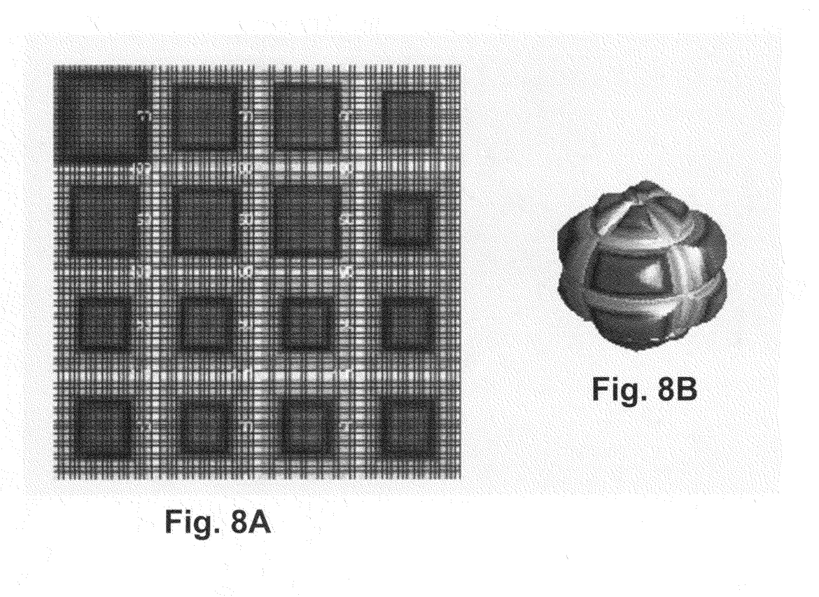

FIG. 8A shows the 2D arrangement, of randomly generated 15-dimension information set with 639 records, made by applying our preferred embodiment. The upper-left sub-window is the overall window and the other five sub-windows are the dimension windows. In this example, data in each dimension ranges from the minimum dimension value to the half of the maximum value in that dimension.

Mapping from 2D to 3D

In our embodiment, we use the inverse function of Mercator projection as an example to convert a 2D panel into a 3D sphere. The inverse function of Mercator projection in Equation <2> below can uniquely map a pixel to a point on a sphere.

φ=2 tan⁻¹(e^{y})−π/2=tan⁻¹(sin h(y)),λ=x+λ₀ <2>

where x and y denote the 2D coordinates of the pixel, φ and λ denote the longitude and latitude, respectively.

The distance of a point to the sphere center equals to the relevance factor (pixel in overall window) or distance (pixel in dimension window). FIG. 8B shows the 3D visualization of FIG. 8A as rendered by the embodiment. Note that the embodiment can render any number of dimensions, and our experiment shows one with 15 dimensions.

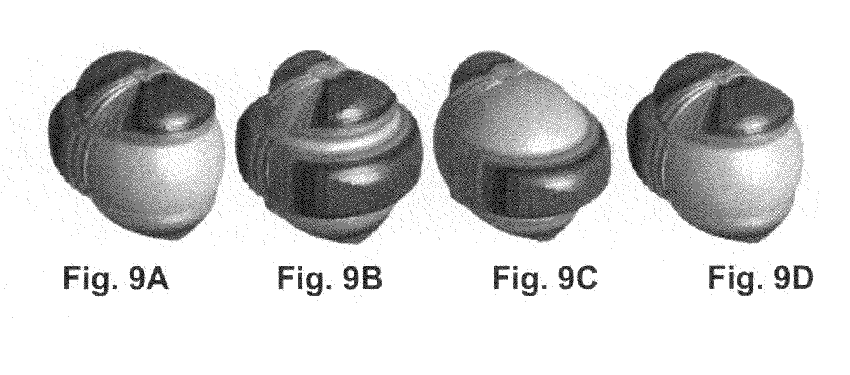

FIGS. 9A-D visualizes four different 5-dimensional information sets. Each dimension is associated with a criterion, set from the minimum value to the half of the maximum value of that dimension. A quick glance at these spheres, one can notice the similarity of FIG. 9A and FIG. 9D, which indicates that the corresponding sets are about the same with respect to the criteria.

Case Study: U.S. Life Table

Now we discuss an example of applying DInfoShape to United States life tables. The data source of the life tables includes the death statistics of U.S. residents during 1999-2001, counts of US resident births during 1997-2001, population estimates based on the 2000 decennial census, population and death counts from the Medicare program during 1999-2001. The visualization provides an intuitive comparison of mortalities of different races or different genders of U.S. population.

Period life tables represent expected life status of a hypothetical cohort as if it experienced throughout its entire life under certain mortality conditions. These mortality conditions are constructed according to collected data of a fixed and relatively short duration. For example, according to the 1999-2001 life tables, the life expectation for American was estimated at 76.83 years. This life expectation is the average age of death for all Americans born in 1999 who are assumed to experience the age-specific death rates prevailing for the actual population in 1999-2001. A period life table can be regarded as a “sketch” of current mortality rates that prevailed at a particular time. Visual comparisons among period life tables reveal the age-specific death rates of different subdivisions of a population and can significantly help demographical analysis.

We apply DInfoShape on five life tables which contain data for the total, males, females, white, and black populations in United States. There are six dimensions in each life table:

Probability of dying (ₙqₓ) measures at the age from x to n+x on the basis of mortality rates of 1999-2001. For example, the probability of dying between 0 and 1 year old is 0.00696 in the life table for total US population, namely, 6.96 out of 1,000 American babies died before reaching their first birth days.

Number of surviving (lₓ) at age x, which is the beginning of each age interval, is calculated by applying ₙqₓ to the survivors of the original cohort at the beginning of each age interval. According to the life table for total US population, 99,305 out of 100,000 American babies successfully passed their first birth days.

Number of dying (ₙdₓ) within an age interval from x to n+x is calculated by multiplying ₙqₓ and lₓ. For example, 695 out of 100,000 American babies died before reaching their first birth days.

Person-years lived (ₙᵢₓ) illustrates the number of person-years lived by the table cohort within an age interval from x to n+x. Therefore, 99,436 in 0-1 age interval is the total number of years lived by the original 100,000 American babies.

Total number of person-years lived (Tₓ) illustrates the total number of person-years of alive persons since the beginning of an age interval from x to n+x. For example, the FIG. 7,584,011 is the total number of years lived by 99,305 American babies after reaching their first birth days.

Expectation of life (eₓ) is the expected average remaining number of years of the survivors who have entered the age x. It is obtained by dividing Tₓ with lₓ. According to the life table of total population, the average expectation of an American is 76.83.

The DInfoShape embodiment can be used to visually compare two life tables. A reference life table includes a set of references. Each figure in the reference life table represents a criterion of a dimension in a specific age interval. A data life table is used to compare with the reference life table. If the data in this table equal those in the reference life table, then we set the distance to zero. If the examined data do not satisfy the criterion, the distance will be the absolute numerical difference.

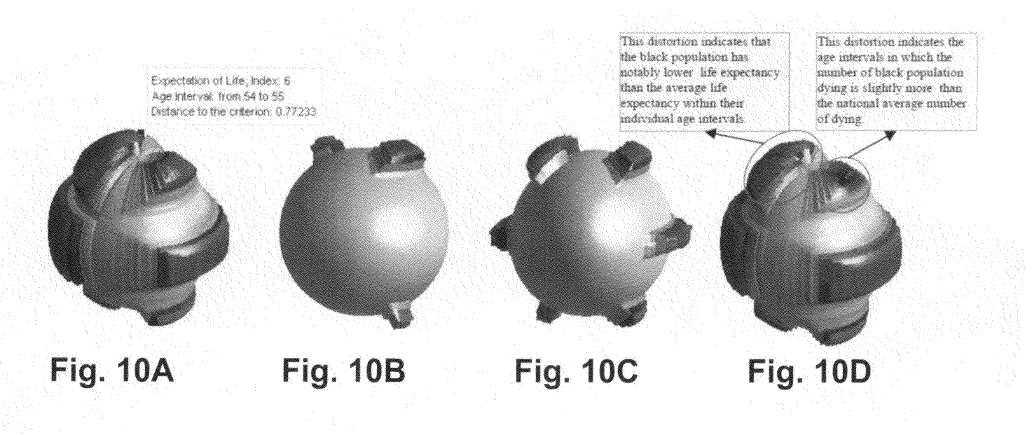

Therefore, if the examined life table exactly satisfies the reference life table, the comparison will be visualized as a perfect sphere; otherwise, it is visualized as a sphere with distortions representing the numerical differences. Users can rotate the sphere and drill down by clicking its surface to view details. The clicked point on the surface is toggled and detailed information of this point is shown in a datatip window as shown in FIG. 10A. The datatip window by default provides information of the selected data, such as dimension, age interval, and the distance to the reference data. Users can customize the information in the datatip window.

FIGS. 10A-D visually compares the life tables of male, female, white and black populations with the life table of the total US population. The sphere for female as shown in FIG. 10B appears to have the least distortions, implying that the female population lives with less probability of death, compared to other three groups. The white population as shown in FIG. 10C lives with a high probability of death than female population, but lower than male and black populations.

Comparing FIG. 10A and FIG. 10D, a viewer would understand that the probabilities of death of male and black populations are almost the same. The size of the distortion indicates the amount of difference of the data from the reference. The bigger the distortion is, the more significant the difference is. For example, as illustrated in FIG. 10D, the distortion of Number of Surviving is much more than that of Number of Dying, indicating that the number of surviving is significantly more than the number of dying.

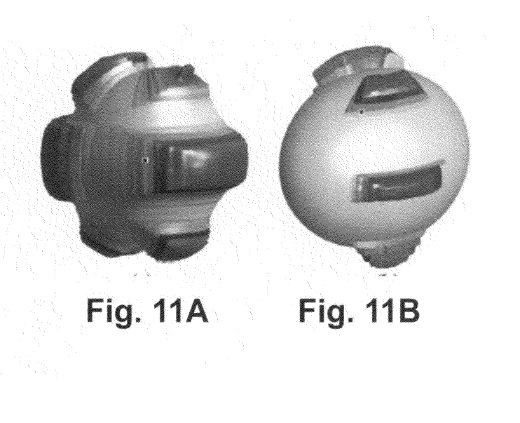

FIGS. 11A & B compare the life tables of white and black populations. FIG. 11A sets the life table for the white population as the reference and that for the black population as the examined data. FIG. 11B visualizes comparisons of the reference and examined data reversed. The fact that FIG. 11B has less distortion than FIG. 11A indicates that white population lives with a less probability of death than black population.

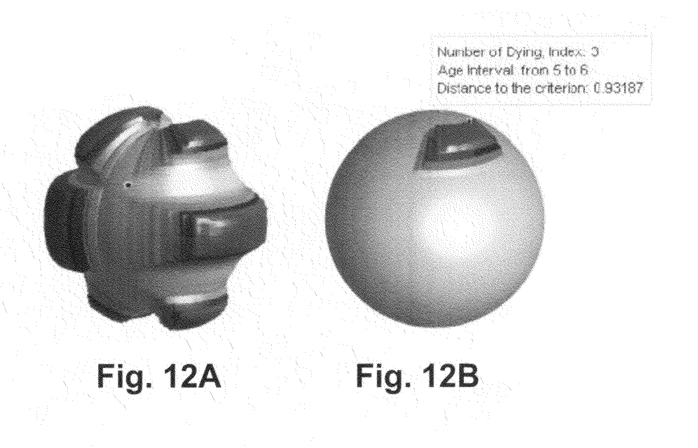

FIGS. 12A & B compare the life tables of male and female populations. The massive distortions on FIG. 12A indicate that the male population life expectation is lower than that of the female population. From FIG. 12B, a viewer can understand that, except the “Number of Dying” dimension, all death data for the female population meet the criterion in the male life table.

Demonstrated above are two fields the invented techniques can be applied to. We believe such invented high-level visual evaluation techniques are useful for many more applications, such as medical testing and examination, product quality and conformance testing, etc., wherever it is valuable for viewers to quickly grasp the overview of a multidimensional information set that is normally hard to comprehend before a detailed perception of local information.

While the present invention has been shown and described herein with reference to specific embodiments thereof, it should be understood by those skilled in the art that variations, alterations, changes in form and detail, and equivalents may be made or conceived of without departing from the spirit and scope of the invention.

The claims as filed are intended to be as comprehensive as possible, and NO subject matter is intentionally relinquished, dedicated, or abandoned.

### APPENDIX

### Calculation of Distance and Relevance Factor

A dimension's approximation of a record is determined by the distance to the criteria, calculated by the distance functions that are data-type and application dependent. For example, metric types can simply use numerical differences; ordinal and nominal data types may apply to distance metrics as distance functions. This embodiment takes metric data types as an example and uses numerical difference as the distance function.

The approximation of a record is determined by the relevance factor, calculated by combining distances of all the dimensions of the record. The distances are initially normalized locally to derive a unique order of magnitude. The relevance factor is the inverse of the Combined Distance value which is calculated using Equation <3> below

CombinedDistanceᵢ=Σ_{j=1 to #sp}wⱼ*dᵢⱼ <3>

where wⱼ (j=1, . . . , #sp) is specified by users and denotes the weighting factors expressing the importance of dimension j. And dᵢⱼ depicts the normalized distance of jth dimension of ith record.

What is claimed is:

1. An apparatus for displaying multiple data records of plural dimensions as a three dimensional shape having a surface, comprising:
a display device displaying at least part of said three dimensional shape, wherein said shape comprises at lease one area on the surface of said shape representing at least one of said data records, and at least one visual feature of said area is responsive to a relevance factor value of its corresponding data record in relation to a non-geographic criterion,
wherein said relevance factor value is determined by an approximation to said criterion.

2. The apparatus of claim 1, wherein said three dimensional shape is a sphere-like shape.

3. The apparatus of claim 1, wherein the distance of said area's surface to the center of said shape is responsive to said relevance factor value.

4. The apparatus of claim 1, wherein said criterion is defined on a subset of said dimensions.

5. The apparatus of claim 1, wherein said visual feature is shape, color, pattern or texture.

6. The apparatus of claim 1, wherein said area is a single pixel.

7. The apparatus of claim 1, wherein said criterion comprises sub-criteria and said relevance factor value is responsive to the combined approximation based on ones of said criteria in a subset of said dimensions.

8. An apparatus for displaying data of a plurality of records as a three-dimensional shape having a surface, comprising:
a memory for storing said data records in a table;
a processor assigning a non-overlapping regular area on the surface of said shape for at least one of said data record, and assigning a surface shape information of said area in dependence of a criterion, wherein said criterion is applied to a subset of said records; and
a display device displaying said area,
wherein said processor sets visual feature of said area based on result of applying a function to said criterion.

9. The apparatus of claim 8, wherein said area is stripe shaped derived from an area distribution function, such as spherical helix function, applied to the surface of said sphere shape.

10. The apparatus of claim 8, said visual feature comprises color or texture and is set such that an area whose corresponding data record does not meet said criterion has a visual feature different to that of an area whose corresponding data record meets said criterion.

11. The apparatus of claim 8, wherein said criterion is a threshold applied on a subset of data from said data record.

12. The apparatus of claim 8, wherein said surface shape is a mathematical function such as F* sphere, Tine, cross or hunch function to the result of said criterion.

13. The apparatus of claim 8, wherein said vision feature comprises color, pattern or texture.

14. An apparatus for displaying data records of plural dimensions as a three-dimensional shape, comprising:
a display device displaying at least part of said three dimensional shape, wherein said shape further comprises an area of plural positions on the surface of said shape, and the steps of deriving ones of said positions comprising the actions of:
assigning at least one pixel to at least one of said records for one of said dimensions, arranging said pixels in a spiral shaped window for one of said data dimensions based on a criterion such that a data record that has a corresponding pixel whose relative distance to the center of said window is responsive to a relevance factor value, wherein said criterion is applied to a subset of said records; and
mapping one of said pixels to one of said positions, wherein the distance of said position to the center of said shape is responsive to said relevance factor value of the data record corresponding to said pixel, wherein said relevance factor value is determined by the approximation to said criterion.

15. The apparatus of claim 14, wherein said three dimensional shape is a sphere- or cubic-like shape.

16. The apparatus of claim 14, wherein said pixel is arranged such that it is closer to the center of said window if its corresponding data record has a worser relevance factor value.

17. The apparatus of claim 14, wherein one of said spiral shaped windows is representitive of all dimensions.

18. The apparatus of claim 14, wherein visual feature information comprises color, pattern or texture and is added for said pixel in responsive to said criterion.

19. The apparatus of claim 14, wherein said pixel comprises plural sub-pixels.

20. The apparatus of claim 14, wherein said relevance factor value is responsive to the combined approximation of a subset of said dimensions.
